(19) United States
(12) Patent Application Publication
(10) Pub. No.: US 2021/0101367 A1
(43) Pub. Date: Apr. 8, 2021

(54) RESIN MATERIAL FOR SLIDING MEMBER, AND SLIDING MEMBER

(71) Applicant: TAIHO KOGYO CO., LTD., Toyota-shi, Aichi (JP)

(72) Inventors: Naoki HORIBE, Toyota (JP); Toru KAWAI, Toyota (JP)

(21) Appl. No.: 16/499,936

(22) PCT Filed: May 22, 2018
(86) PCT No.: PCT/JP2018/019590

§ 371 Date: Oct. 1, 2019

(30) Foreign Application Priority Data
May 22, 2017 (JP) 2017-100962

(51) Int. Cl. B32B 15/08; B32B 27/28; B32B 27/18; B32B 15/18; B32B 15/20; B22F 7/04; C08K 3/04; C08K 5/5415; C08L 79/08; F16C 33/16

(52) U.S. Cl. CPC B32B 15/08; B32B 27/281; B32B 27/18; B32B 15/18; B32B 15/20; B05D 1/42; C08K 3/04; C08K 5/5415; C08L 79/08; F16C 33/16; B22F 7/04

(57) ABSTRACT

A resin material for a sliding member includes 80 vol % or more of a polyimide resin, 9.5 vol % or more and 20 vol % or less in total of graphite and a hard substance, and 0.1 wt % or more of a silane coupling agent relative to the polyimide resin, and a balance of residual inevitable impurities.

### CROSS-REFERENCE TO RELATED APPLICATIONS

This application is a U.S. National Stage Application of International Application No. PCT/JP2018/019590, filed on May 22, 2018, which claims priority to Japanese Application No. 2017-100962, filed on May 22, 2017. The entire disclosures of the above applications are incorporated herein by reference.

### BACKGROUND

### Technical Field

The present invention relates to a resin material for a sliding member, and to a sliding member for which the resin material is used.

### Related Art

As a resin material used for a sliding member, there is known in the art that graphite is added to a binder resin to form a resin material. JP 5683571B discloses a resin material containing graphite particles of a generally spherical shape.

In the material disclosed in JP 5683571B room for improvement exists with regard to fatigue resistance of the resin material.

The present invention provides a resin material for a sliding member, which material has improved fatigue resistance.

### SUMMARY

The present invention provides a resin material for a sliding member comprising 80 vol % or more of a polyimide resin, 9.5 vol % or more and 20 vol % or less of a graphite and a hard material, 0.1 wt % or more of a silane coupling agent with respect to the polyimide resin, and the inevitable impurities.

The content of the graphite and the hard material may be 15 vol % or less in total.

The content of the graphite may be 9 vol % or more and 18 vol %

The content of the graphite may be 15 vol % or less.

The content of the hard substance may be 0.5 vol % or more and 3 vol % or less.

The content of the polyimide resin may be 90 vol % or more.

The polyimide resin may be a high strength polyimide resin.

The resin material for the sliding member may not contain MoS₂.

The present invention also provides a sliding member that includes a base material, a sintered metal layer formed on the base material, and a resin layer formed on the sintered metal layer, the resin layer being formed from the resin material for the above sliding member.

### Effect of the Invention

The present invention provides improved fatigue resistance in the resin material used for the sliding member.

### BRIEF DESCRIPTION OF THE DRAWINGS

FIG. 1 is a diagram showing a cross-sectional structure of a sliding member 1 according to an embodiment.

### DETAILED DESCRIPTION

### 1. Configuration

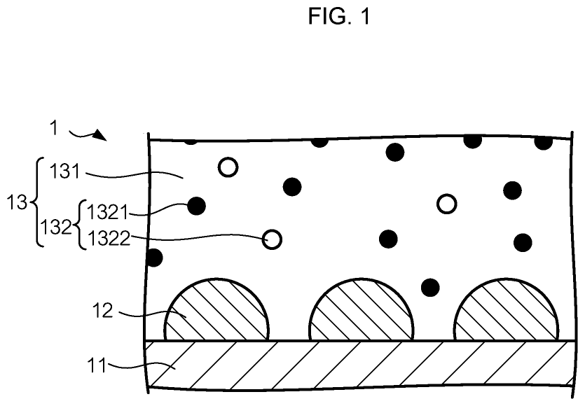

FIG. 1 shows in cross section an exemplary structure of a sliding member 1 according to an embodiment. The sliding member 1 is, for example, a sliding member used as a bush in a fuel injection pump. The sliding member 1 includes a base material 11, a sintered layer 12, and a resin layer 13. The base material 11 is a layer that provides both the shape and mechanical strength of the sliding member 1. The base material 11 is formed of, for example, a steel. The base material 11 is a backing metal. The sintered layer 12 improves adhesion between the resin layer 13 and the base material 11, and is a sintered metal layer formed of a metal powder, for example, a powder of copper or a copper alloy.

The resin layer 13 is formed of a resin material for a sliding member. The resin material includes a binder resin 131 and an additive 132 dispersed in the binder resin 131. As the binder resin 131, for example, a thermosetting resin, more specifically, for example, at least one of a polyimide (PI) resin and a polyamide imide (PAI) resin may be used. To improve fatigue resistance, it is preferable that a PI resin rather than a PAI resin is used; and among PI resins, use of a PI resin having a high strength (here, “high strength” refers to a PI resin having a tensile strength of 150 MPa or more) is preferable. To improve fatigue resistance, it is preferable that a content of the binder resin in the resin layer 13 is large; for example, 80 vol % or more, more preferably 83 vol % or more, still more preferably 85 vol % or more, and still more preferably 90 vol % or more.

The additive 132 is a substance that improves the characteristics of the resin layer 13, and may include, for example, at least one of a solid lubricant 1321, a hard substance (hard particle) 1322, and a silane coupling agent (the silane coupling agent is not shown). The solid lubricant 1321 is an additive that is used to reduce the frictional coefficient of the resin layer 13, and includes, for example, at least one of graphite and MoS₂. It is preferable that graphite is used as the solid lubricant 1321, rather than MoS₂. This is because of a likelihood in some cases that MoS₂ will aggregate in the resin layer. When graphite is used as the solid lubricant 1321, in order to reduce a friction coefficient, it is preferable that a degree of graphitization is high, for example, 95% or more, and more preferably 99% or more. The hard material 1322 is a material used to improve seizure resistance and abrasion resistance of the resin layer 13, and includes, for example, at least one of clay, mullite, and talc. The silane coupling agent is a substance used to strengthen a bond between the binder resin 131 and the solid lubricant 1321.

To improve fatigue resistance, it is preferable that a content of the additive is small, for example, 20 vol % or less in total, more preferably 17 vol % or less, still more preferably 15 vol % or less, and still more preferably 10 vol % or less. To reduce the coefficient of friction, it is preferable that the content of the solid lubricant is large, for example, 9 vol % or more. To reduce the total amount of the additive, it is preferable that the content of the solid lubricant is small, for example, 18 vol % or less. To improve the seizure resistance and the abrasion resistance, it is preferable that the content of the hard substance is large, for example, 0.5 vol % or more. To reduce the total amount of the additive, it is preferable that the content of the solid lubricant is small, for example, 3 vol % or less. For addition of both the solid lubricant and the hard material, it is preferable that the content of the solid lubricant is 9 vol % or more and 17 vol % or less, and still more preferably 14 vol % or less; and it is preferable that the content of the hard material is between 0.5 vol % and 3 vol %. It is preferable that the content of the silane coupling agent relative to the binder resin is, for example, 0.1 wt % or more, more preferably 0.2 wt % or more. To reduce costs, it is preferable that the content of the silane coupling agent relative to the binder resin is, for example, 5 wt % or less, and more preferably 3 wt % or less.

To reduce the surface roughness after the cutting process, it is preferable that the particle diameter of the material used as the additive 132 is small; for example, it is preferable that the average particle diameter of the additive 132 is smaller than the average particle diameter of the metal powder used for the sintered layer 12. Further, it is preferable that both the solid lubricant 1321 and the hard material 1322 have an average particle diameter of 5 μm or less, and more preferably 3 μm or less.

Since the resin layer 13 is used as a sliding member, it is preferable that the fatigue resistance strength, that is, the fatigue surface pressure is 55 MPa or more. The method used to measure the fatigue surface pressure will be described later. To improve the fatigue resistance of the resin layer 13, it is preferable that the average particle diameter of the solid lubricant 1321 used as the material is small; for example, preferably twice or less the average particle diameter of the hard material 1322, and more preferably smaller than the average particle diameter of the hard material 1322.

The fatigue resistance of the resin layer 13 decreases as the content of the additive 132 increases. In the present embodiment, the fatigue resistance is improved by suppressing the content of the additive.

### 2. Embodiment

The inventors of the present application produced test samples of the sliding member under various conditions, and evaluated the fatigue resistance of the test pieces.

### 2-1. Preparation of Test Samples

As a base material, a steel plate (SPCC) having a thickness of 1.5 mm was used. Copper alloy powder having an average particle diameter of 100 μm was sprayed on the base material to a thickness of 100 μm and then heated to 930° C. to sinter the layer, in a reducing atmosphere without being depressed. The precursor solution for forming the resin layer of the composition in Table 1 was prepared and the precursor solution was applied over the sintered layer by use of a knife coating method. After application of the precursor solution, the resultant work was dried at a temperature ranging from room temperature to about 200° C., for about 60 to 90 minutes. Thereafter, the temperature was raised to about 300° C. for a period of 30 to 90 minutes to effect firing.

In Experiment Examples 1 to 5, graphite having an average particle diameter (d50 on a volume basis) of 1.5 μm and a degree of graphitization of 99% was used. As the high-strength PI resin, a PI resin having a tensile strength of 195 MPa, an elongation of 90%, an elastic modulus of 3.8 GPa, and a glass-transition temperature Tg of 285° C. was used. In Experiment Example 6, graphite having an average particle diameter of 12.5 μm and a graphitization degree of 90% was used. The MoS₂ used had a mean particle size of 1.5 μm. Further, a PI resin having a tensile strength of 119 MPa, an elongation of 47%, and a glass transition temperature Tg of 360° C. was used, and a PAI resin having a tensile strength of 112 MPa, an elongation of 17%, an elastic modulus of 2.7 GPa, and a glass transition temperature Tg of 288° C., was used. In Experiment Examples 2 to 5, a silane coupling agent having a chemical formula of 3 (H₃CO)SiC₃H₆—NH—C₃H₆Si(OCH₃)₃) was used. In Table 1, the content of the silane coupling agent is shown in weight ratio to the high strength PI resin. In Experiment Examples 1 to 6, clays having a structural formula of Al₂O₃.2SiO₂ and a mean particle diameter of 3 micrometers were used.

In Experiment Examples 1 to 5, only graphite was used as the solid-state lubricant, i.e., MoS₂ was not used as the solid-state lubricant. Each additive had an average particle size of 3 μm or less.

2-2. Fatigue Resistance Evaluation

Fatigue tests were performed on the test samples of Experiment Example 1 and Experiment Example 2. The fatigue test was conducted under the following conditions, with a maximum surface pressure at which no fatigue occurred in the resin layer being set as the fatigue surface pressure.
Tester: Reciprocating load tester
Rotation speed: 3000 rpm
Test temperature (bearing back temperature): 100° C.
Opposing material: S45 C
Lubricating oil: paraffin oil

Table 1 shows the compositions of Experiment Examples 1 to 6 and the results of the fatigue test.

TABLE 1

| | | | | Binder resin | | | | Fatigue |
|---|---|---|---|---|---|---|---|---|
| | | | Hard | | | | Silane | resistance |
| | Solid lubricant | | material | | | | coupling | Fatigue |
| | Graphite | MoS₂ | Clay | High | | | agent | surface |
| | Content | Content | Content | strength | | | Content | pressure |
| | (vol %) | (vol %) | (vol %) | PI | PI | PAI | (wt %) | (MPa) |
| EXPERIMENT | 9 | — | 1 | 90 | — | — | — | ≤60 |
| EXAMPLE 1 | | | | | | | | |
| EXPERIMENT | 9 | — | 1 | 90 | — | — | 0.25 | 90 |
| EXAMPLE 2 | | | | | | | | |
| EXPERIMENT | 9 | — | 1 | 90 | — | — | 1 | 90 |
| EXAMPLE 3 | | | | | | | | |
| EXPERIMENT | 9 | — | 1 | 90 | — | — | 3 | ≥100 |
| EXAMPLE 4 | | | | | | | | |
| EXPERIMENT | 18 | — | 2 | 80 | — | — | 1 | 40 |
| EXAMPLE 5 | | | | | | | | |
| EXPERIMENT | 17 | 10 | 3 | — | 35 | 35 | — | 20 |
| EXAMPLE 6 | | | | | | | | |

The total amount of the additive is 30 vol % in Experiment Example 6, 20 vol % in Experiment Example 5, and 10 vol % in Experiment Examples 1 to 4. Compared to Experiment Example 6, in at least Experiment Examples 2 to 5 improved fatigue resistance was shown. Furthermore, in at least Experiment Examples 2 to 4 improved fatigue resistance was shown when compared with Experiment Examples 5 and 6.

The silane coupling agent was not added in Experiment Example 1, but was added in Experiment Examples 2 to 4, in amounts of 0.25 wt %, 1 wt %, and 3 wt %, respectively, relative to the high strength PI resin. Compared to Experiment Example 1, in Experiment Examples 2 to 4 improved fatigue resistance was shown.

It is noted that the various materials and compositions used in the above examples are mere examples, and the present invention is not limited thereto. The resin material according to the present invention may contain (residual) inevitable impurities. The specific structure of the sliding member is not limited to the example illustrated in FIG. 1. For example, the sintered layer 12 may be omitted, and the resin layer 13 may be formed directly on the base material 11. Further, application of the sliding member 1 is not limited to use as a bush in a fuel injection pump, and may be applied for use in various bearings, compressors, or the like.

1. A resin material for a sliding member, comprising:
more than 80 vol % of polyimide resin;
9.5 vol % or more and 20 vol % or less of graphite and hard material in total;
0.1 wt % or more of the silane coupling agent relative to the polyimide resin; and
the balance of inevitable impurities.

2. The resin material for a sliding member according to claim 1, wherein
the content of the graphite and the hard material is 15 vol % or less in total.

3. The resin material for a sliding member according to claim 1, wherein
the content of the graphite is 9 vol % or more and 18 vol % or less.

4. The resin material for a sliding member according to claim 3, wherein
the content of the graphite is 15 vol % or less.

5. The resin material for a sliding member according to claim 1, wherein
the content of the hard substance is not less than 0.5 vol % and not more than 3 vol %.

6. The resin material for a sliding member according to claim 1, wherein
the content of the polyimide resin is 90 vol % or more.

7. The resin material for a sliding member according to claim 1, wherein
the polyimide resin is a high strength polyimide resin.

8. The resin material for a sliding member according to claim 1, wherein
the resin material does not contain MoS₂.

9. A sliding member comprising:
a base material;
a sintered metal layer formed on the base material, a resin layer formed on the sintered metal layer and formed of a resin material for a sliding member including:
more than 80 vol % of polyimide resin;
9.5 vol % or more and 20 vol % or less of graphite and hard material in total;
0.1 wt % or more of the silane coupling agent relative to the polyimide resin; and
the balance of inevitable impurities.

10. The resin material for a sliding member according to claim 2, wherein
the content of the graphite is 9 vol % or more and 18 vol % or less.

11. The resin material for a sliding member according to claim 10, wherein
the content of the graphite is 15 vol % or less.
